(19) United States
(12) Patent Application Publication
(10) Pub. No.: US 2013/0275037 A1
(43) Pub. Date: Oct. 17, 2013

(54) Consumer Information and Navigation System for Nutritional Substances

(71) Applicant: Eugenio MINVIELLE, Rye, NY (US)

(72) Inventor: Eugenio MINVIELLE, Rye, NY (US)

(21) Appl. No.: 13/732,050

(22) Filed: Dec. 31, 2012

Related U.S. Application Data
(63) Continuation-in-part of application No. 13/485,878, filed on May 31, 2012.
(60) Provisional application No. 61/624,800, filed on Apr. 16, 2012.
(60) Provisional application No. 61/624,980, filed on Apr. 16, 2012.
(60) Provisional application No. 61/624,989, filed on Apr. 16, 2012.

(51) Int. Cl. G06F 17/30; G01C 21/20

(52) U.S. Cl. CPC G06F 17/30386; G01C 21/206
USPC 701/408; 707/705

(57) ABSTRACT

Disclosed herein is a consumer information and navigation system for nutritional substances. The consumer information and navigation system obtains information regarding the nutritional substance sought for consumption by a consumer, provides that information to the other constituents in the nutritional substance supply system, and provides an indoor navigation system to locate such nutritional substances.

### RELATED PATENT APPLICATIONS

This application is a continuation-in-part of Utility application Ser. No. 13/485,878 filed May 31, 2012 (Attorney Docket No. 053883-034), which claims priority to U.S. Provisional Patent Application Ser. No. 61/624,800, filed Apr. 16, 2012; U.S. Provisional Patent Application Ser. No. 61/624,980, filed Apr. 16, 2012; and U.S. Provisional Patent Application, 61/624,989, filed Apr. 16, 2012, the contents of which are incorporated herein by reference in their entirety.

### FIELD OF THE INVENTION

The present inventions relate to consumer information systems for nutritional substances using information regarding source, preservation and current information, prior transformation information, consumer preference information, including recipe information for tracking consumer's needs and preferences, and/or providing feedback to harvesters, preservers, transformers and conditioners of nutritional substance.

### BACKGROUND OF THE INVENTION

Nutritional substances are traditionally grown (plants), raised (animals) or synthesized (synthetic compounds). Additionally, nutritional substances can be found in a wild, non-cultivated form, which can be caught or collected. While the collectors and creators of nutritional substances generally obtain and/or generate information about the source, history, caloric content and/or nutritional content of their products, they generally do not pass such information along to the users of their products. One reason is the nutritional substance industries have tended to act like “silo” industries. Each group in the food and beverage industry: growers, packagers, processors, distributors, retailers, and preparers work separately, and either shares no information, or very little information, between themselves. There is generally no consumer access to, and little traceability of, information regarding the creation and/or origin, preservation, processing, preparation, or consumption of nutritional substances. It would be desirable for such information be available to the consumers of nutritional substances, as well as all participants in the food and beverage industry—the nutritional substance supply system.

While the nutritional substance supply system has endeavored over the last 50 years to increase the caloric content of nutritional substances produced (which has help reduce starvation in developing countries, but has led to obesity problems in developed countries), maintaining, or increasing, the nutritional content of nutritional substances has been a lower priority. Caloric content refers to the energy in nutritional substances, commonly measured in calories. The caloric content could be represented as sugars and/or carbohydrates in the nutritional substances. The nutritional content, also referred to herein as nutritional value, of foods and beverages, as used herein, refers to the non-caloric content of these nutritional substances which are beneficial to the organisms which consume these nutritional substances. For example, the nutritional content of a nutritional substance could include vitamins, minerals, proteins, and other non-caloric components which are necessary, or at least beneficial, to the organism consuming the nutritional substances. NOTE: Certain nutrients provide calories: 1 gram of: protein has 4 calories, alcohol has 7 calories, fat has 9 calories and carbohydrates have 4 calories. Non caloric are water, vitamins, minerals, fiber and cholesterol.

While there has recently been greater attention by consumer organizations, health organizations and the public to the nutritional content of foods and beverages, the food and beverage industry has been slow in responding to this attention. One reason for this may be that since the food and beverage industry operates as silos of those who create nutritional substances, those who preserve and transport nutritional substances, those who transform nutritional substances, and those who finally prepare the nutritional substances for consumption by the consumer, there has been no system wide coordination or management of nutritional content. While each of these silo industries may be able to maintain or increase the nutritional content of the foods and beverages they handle, each silo industry has only limited information and control of the nutritional substances they receive, and the nutritional substances they pass along.

As consumers better understand their need for nutritional substances with higher nutritional content, they will start demanding that the food and beverage industry offer products which include higher nutritional content, and/or at least information regarding nutritional content of such products. In fact, consumers are already willing to pay higher prices for higher nutritional content. This can be seen at high-end grocery stores which offer organic, minimally processed, fresh, non-adulterated nutritional substances. Further, as societies and governments seek to improve their constituents' health and lower healthcare costs, incentives and/or mandates will be given to the food and beverage industry to track, maintain, and/or increase the nutritional content of nutritional substances they handle. There will be a need, not only within each food and beverage industry silo to maintain or improve the nutritional content of their products, but an industry-wide solution to allow the management of nutritional content across the entire cycle from creation to consumption. In order to manage the nutritional content of nutritional substances across the entire cycle from creation to consumption, the nutritional substance industry will need to identify, track, measure, estimate, preserve, transform, condition, and record nutritional content for nutritional substances. Of particular importance is the measurement, estimation, and tracking of changes to the nutritional content, also referred to herein as ΔN, of a nutritional substance from creation to consumption. This ΔN information could be used, not only by the consumer in selecting particular nutritional substances to consume, but could be used by the other food and beverage industry silos, including creation, preservation, transformation, and conditioning, to make decisions on how to create, handle and process nutritional substances. Additionally, those who sell nutritional substances to consumers, such as restaurants and grocery stores, could communicate perceived qualitative values of the nutritional substance in their efforts to market and position their nutritional substance products. Further, a determinant of price of the nutritional substance could be particular nutritional, organoleptic, or aesthetic values, and if changes to those values, also referred to herein as ΔN, are perceived as desirable. For example, if a desirable value has been maintained, improved, or minimally degraded, it could be marketed as a premium product.

For example, the grower of sweet corn generally only provides basic information as the variety and grade of its corn to the packager, who preserves and ships the corn to a producer for use in a ready-to-eat dinner. The packager may only tell the producer that the corn has been frozen as loose kernels of sweet corn. The producer may only provide the consumer with rudimentary instructions how to cook or reheat the ready-to-eat dinner in a microwave oven, toaster oven or conventional oven, and only tell the consumer that the dinner contains whole kernel corn among the various items in the dinner. Finally, the consumer of the dinner will likely keep her opinions on the quality of the dinner to herself, unless it was an especially bad experience, where she might contact the producer's customer support program to complain. Very minimal, or no, information on the nutritional content of the ready-to-eat dinner is passed along to the consumer. The consumer knows essentially nothing about changes, (generally a degradation, but could be a maintenance or even an improvement) to the nutritional content, ΔN, of the sweet corn from creation, processing, packaging, cooking, preservation, preparation by consumer, and finally consumption by the consumer.

Consumers' needs are changing as consumers are demanding healthier foods, such as “organic foods.” Customers are also asking for more information about the nutritional substances they consume, such as specific characteristics' relating not only to nutritional content, but also to allergens or digestive intolerances. For example, nutritional substances which contain lactose, gluten, nuts, dyes, etc. need to be avoided by certain consumers. However, the producer of the ready-to-eat dinner, in the prior example, has very little information to share other than possibly the source of the elements of the ready-to-eat dinner and its processing steps in preparing the dinner. Generally, the producer of the ready- to-eat dinner does not know the nutritional content and organoleptic state and aesthetic condition of the product after it has been reheated or cooked by the consumer, cannot predict changes to these properties, ΔN, and cannot inform a consumer of this information to enable the consumer to better meet their needs. For example, the consumer may want to know what proportion of desired organoleptic properties or values, desired nutritional content or values, or desired aesthetic properties or values of the corn in the ready-to-eat dinner remain after cooking or reheating, and the change in the desired nutritional content or values, the desired organoleptic properties or values, or the desired aesthetic properties or values, ΔN, (usually a degradation, but could be a maintenance or even improvement). There is a need to preserve, measure, estimate, store and/or transmit information regarding such nutritional, organoleptic, and aesthetic values, including changes to these values, ΔN, throughout the nutritional substance supply system. Given the opportunity and a system capable of receiving and processing real time consumer feedback and updates regarding changes in the nutritional, organoleptic, and/or aesthetic value of nutritional substances, ΔN, consumers can even play a role in updating dynamic information about the nutritional substances they have purchased and/or prepared for consumption, such that that information is available and useful to others in the nutritional substance supply system.

The caloric and nutritional content information for a prepared food that is provided to the consumer is often minimal. For example, when sugar is listed in the ingredient list, the consumer may not receive any information about the source of the sugar, which can come from a variety of plants, such as sugarcane, beets, or corn, which will affect its nutritional content. Conversely, some nutritional information that is provided to consumers is so detailed, the consumer can do little with it. For example, this is a list of ingredients is from a nutritional label on a consumer product: Vitamins—A 355 IU 7%, E 0.8 mg 4%, K 0.5 mcg, 1%, Thiamin 0.6 mg 43%, Riboflavin 0.3 mg 20%, Niacin 6.0 mg 30%, B6 1.0 mg 52%, Foliate 31.5 mcg 8%, Pantothenic 7%; Minerals Calcium 11.6 1%, Iron 4.5 mg 25%, Phosphorus 349 mg 35%, Potassium 476 mg 14%, Sodium 58.1 mg 2%, Zinc 3.7 mg 24%, Copper 0.5 mg 26%, Manganese 0.8 mg 40%, Selenium 25.7 mcg 37%; Carbohydrate 123 g, Dietary fiber 12.1 g, Saturated fat 7.9 g, Monosaturated Fat 2, 1 g, Polysaturated Fat 3.6 g, Omega 3 fatty acids 108 g, Omega 6 fatty acids 3481, Ash 2.0 g and Water 17.2 g. (%=Daily Value). There is a need to provide information about nutritional substances in a meaningful manner. Such information needs to be presented in a manner that meets the specific needs of a particular consumer. For example, consumers with a medical condition, such as diabetes, would want to track specific information regarding nutritional values associated with sugar and other nutrients in the foods and beverages they consume, and would benefit further from knowing changes in these values or having tools to quickly indicate or estimate these changes in a retrospective, current, or prospective fashion, and even tools to report these changes, or impressions of these changes, in a real-time fashion.

If fact, each silo in the food and beverage industry already creates and tracks some information, including caloric and nutritional information, about their product internally. For example, the farmer who grew the corn knows the variety of the seed, condition of the soil, the source of the water, the fertilizers and pesticides used, and can measure the caloric and nutritional content at creation, in this case, at harvest. The packager of the corn knows when it was picked, how it was transported to the packaging plant, how the corn was preserved and packaged before being sent to the ready-to-eat dinner producer, when it was delivered to the producer, and what degradation to caloric and nutritional content has occurred. The producer knows the source of each element of the ready-to-eat dinner, how it was processed, including the recipe followed, and how it was preserved and packaged for the consumer. Not only does such a producer know what degradation to caloric and nutritional content occurred, the producer can modify its processing and post-processing preservation to minimally affect nutritional content. The preparation of the nutritional substance for consumption can also degrade the nutritional content of nutritional substances. Finally, the consumer knows how she prepared the dinner, what condiments were added, and whether she did or did not enjoy it.

If there was a mechanism to share this information, the quality of the nutritional substances, including caloric and nutritional, organoleptic, and aesthetic value, could be preserved and improved. Consumers could be better informed about nutritional substances they select and consume, including the state, and changes in the state, the ΔN, of the nutritional substance throughout its lifecycle from creation to consumption. The efficiency and cost effectiveness of nutritional substances could also be improved. Feedback within the entire chain from creator to consumer could provide a closed-loop system that could improve quality (taste, appearance, and caloric and nutritional content), efficiency, value and profit. For example, in the milk supply chain, at least 10% of the milk produced is wasted due to safety margins included in product expiration dates. The use of more accurate tracking information, measured quality (including nutritional content) information, and historical environmental information could substantially reduce such waste. Collecting, preserving, measuring and/or tracking information about a nutritional substance in the nutritional substance supply system, would allow needed accountability. There would be nothing to hide.

As consumers are demanding more information about what they consume, they are asking for products that have higher nutritional content and more closely match good nutritional requirements, and would like nutritional products to actually meet their specific nutritional requirements. While grocery stores, restaurants, and all those who process and sell food and beverages may obtain some information from current nutritional substance tracking systems, such as labels, these current systems can provide only limited information.

All through the nutritional substance supply and consumption chain the various suppliers benefit from feedback from consumers further up the supply chain. However, such feedback is disorganized and haphazard and can only be traced generally to the actual nutritional substances being commented on.

An important issue in the creation, preservation, transformation, conditioning, and consumption of nutritional substances are the changes in nutritional, organoleptic, or aesthetic values, ΔN, that occur in nutritional substances due to a variety of internal and external factors. Because nutritional substances are composed of biological, organic, and/or chemical compounds, they are generally subject to degradation. This degradation generally reduces the nutritional, organoleptic, and/or aesthetic values of nutritional substances. While not always true, nutritional substances are best consumed at their point of creation. However, being able to consume nutritional substances at the farm, at the slaughterhouse, at the fishery, or at the food processing plant is at least inconvenient, if not impossible. Currently, the food and beverage industry attempts to minimize the loss of nutritional value (often through the use of additives or preservatives), and/or attempts to hide this loss of nutritional value from consumers.

Overall, the examples herein of some prior or related systems and their associated limitations are intended to be illustrative and not exclusive. Other limitations of existing or prior systems will become apparent to those of skill in the art upon reading the following Detailed Description.

### OBJECTS OF THE INVENTION

It is an object of the present invention to obtain consumer feedback on the consumption of the nutritional substance, including feedback regarding changes in nutritional, organoleptic, and/or aesthetic values of the nutritional substance, herein referred to as ΔN, observed or measured by consumers, and provide such feedback to one or more of the nutritional substance creator, packager, transformer, conditioner, and/or consumer.

An additional object of the present invention is to create a multi-dimensional nutritional substance database receiving and transmitting consumer feedback on the consumption of nutritional substances, including feedback regarding changes in nutritional, organoleptic, and/or aesthetic values of nutritional substances, herein referred to as ΔN, observed or measured by consumers, for use and analysis by the nutritional substance creator, packager, transformer, conditioner, and/or consumer.

It is an object of the present invention to minimize and/or track degradation of nutritional, organoleptic, and/or aesthetic value of nutritional substances, and/or collect, store, and/or transmit information regarding this degradation.

### SUMMARY OF THE INVENTION

In an embodiment of the present invention information regarding a change of nutritional, organoleptic, and/or aesthetic value of a nutritional substance and/or component nutritional substances thereof, collectively and individually referred to herein as ΔN, is: measured or collected or calculated or created or estimated or indicated or determined in any suitable manner; stored and/or tracked and/or transmitted and/or processed prior to conditioning and/or following conditioning and/or prior to consumption and/or after consumption, such that the degradation of specific nutritional, organoleptic, and/or aesthetic values can be minimized and specific residual nutritional, organoleptic, and/or aesthetic value can be optimized. A change of nutritional, organoleptic, and/or aesthetic value, ΔN, may not occur, in which case ΔN would be zero. The change of nutritional, organoleptic, and/or aesthetic value, ΔN, may be a degradation, in which case ΔN would be negative. The change of nutritional, organoleptic, and/or aesthetic value, ΔN, may be an improvement, in which case ΔN would be positive.

In one embodiment of the present invention, consumer feedback information regarding consumed nutritional substances is collected and correlated to the source, packaging, transformation and/or conditioning information. Such information could be made available to the creator, packager, transformer conditioner, and/or consumer of the nutritional substance and could include feedback regarding changes in nutritional, organoleptic, and/or aesthetic values of nutritional substances, herein referred to as ΔN, observed or measured by consumers.

In another embodiment of the present invention, such correlated information, including information regarding ΔN, would be stored and analyzed and transmitted by a multi-dimensional database for use and analysis by the nutritional substance creator, packager, transformer, conditioner, and/or consumer.

An embodiment of the present invention provides a system for the creation, collection, storage, transmission, and/or processing of information regarding nutritional substances so as to improve, maintain, or minimize degradation of nutritional, organoleptic, and/or aesthetic value of nutritional substances. Additionally, the present invention provides such information for use by the creators, preservers, transformers, conditioners, and consumers of nutritional substances. The nutritional information creation, preservation, and transmission system of the present invention should allow the nutritional substance supply system to improve its ability to minimize degradation of nutritional, organoleptic and/or aesthetic value of the nutritional substance, and/or inform the consumer, creator, packager, transformer, or conditioner about such degradation, or ΔN. The ultimate goal of the nutritional substance supply system is to minimize degradation of nutritional, organoleptic and/or aesthetic values, or as it relates to ΔN, minimize the negative magnitude of ΔN. However, an interim goal should be providing consumers with significant information regarding any change, particularly degradation, of nutritional, organoleptic and/or aesthetic values of nutritional, and/or component nutritional substances thereof that consumers select and consume, (i.e., the ΔN) such that desired information regarding specific residual nutritional, organoleptic, and/or aesthetic values can be ascertained using the ΔN. Entities within the nutritional substance supply system who provide such ΔN information regarding nutritional substances, particularly regarding degradation, will be able to differentiate their products from those who obscure and/or hide such information. Additionally, such entities should be able to charge a premium for products which either maintain their nutritional, organoleptic, and/or aesthetic value, or supply more complete information about changes in their nutritional, organoleptic, and/or aesthetic value, the ΔN. Further, entities that supply conditioning equipment and other devices enabling consumer access and utilization of ΔN information will be able to differentiate their products from those that do not enable the consumer to access and utilize ΔN information. Such conditioning equipment will allow consumers to minimize degradation of, preserve, or improve the nutritional, organoleptic, and/or aesthetic value of the nutritional substances they consume. Such conditioners will further enable the consumer to optimize the nutritional, organoleptic, and/or aesthetic value of the nutritional substances they condition and consume according to their individual needs and/or desires.

In an embodiment of the present invention, observed or measured ΔN information can also be provided by consumers, so that it can be received and reflected through reporting or modification of a nutritional substance database. In this way, consumer reports regarding observed or measured changes in nutritional, organoleptic, and/or aesthetic values, the ΔN, of nutritional substances they have purchased, are going to prepare, or are going to consume, are in some way incorporated into a nutritional substance database.

Other advantages and features will become apparent from the following description and claims. It should be understood that the description and specific examples are intended for purposes of illustration only and not intended to limit the scope of the present disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 shows a schematic functional block diagram of a nutritional substance supply relating to the present invention;

FIG. 2 shows a graph representing a value of a nutritional substance which changes according to a change of condition for the nutritional substance;

FIG. 3 shows a schematic functional block diagram of the consumer information module 600 according to the present invention;

FIG. 4 shows a schematic functional block diagram of the consumer information module 600 according to an alternate embodiment of the present invention;

FIG. 5 shows a schematic functional block diagram of the consumer information module 600 according to an alternate embodiment of the present invention;

FIG. 6 shows a schematic functional block diagram of the consumer information module 600 according to an alternate embodiment of the present invention;

FIG. 7 shows a schematic functional block diagram of the consumer information module 600 according to an alternate embodiment of the present invention; and

FIG. 8 shows a schematic functional block diagram of the consumer information module 600 according to an alternate embodiment of the present invention.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

The following discussion provides a brief, general description of a representative environment in which the invention can be implemented. Although not required, aspects of the invention may be described below in the general context of computer-executable instructions, such as routines executed by a general-purpose data processing device (e.g., a server computer or a personal computer). Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “controller,” “computer,” “server,” and the like are used interchangeably herein, and may refer to any of the above devices and systems.

While aspects of the invention, such as certain functions, are described as being performed exclusively on a single device, the invention can also be practiced in distributed environments where functions or modules are shared among disparate processing devices. The disparate processing devices are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the invention may be distributed over the Internet or over other networks (including wireless networks), on a propagated signal on a propagation medium (e.g., an electromagnetic wave(s), a sound wave, etc.) over a period of time. In some implementations, the data may be provided on any analog or digital network (packet switched, circuit switched, or other scheme).

In some instances, the interconnection between modules is the internet, allowing the modules (with, for example, WiFi capability) to access web content offered through various web servers. The network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The modules in the systems can be understood to be integrated in some instances and in particular embodiments, only particular modules may be interconnected.

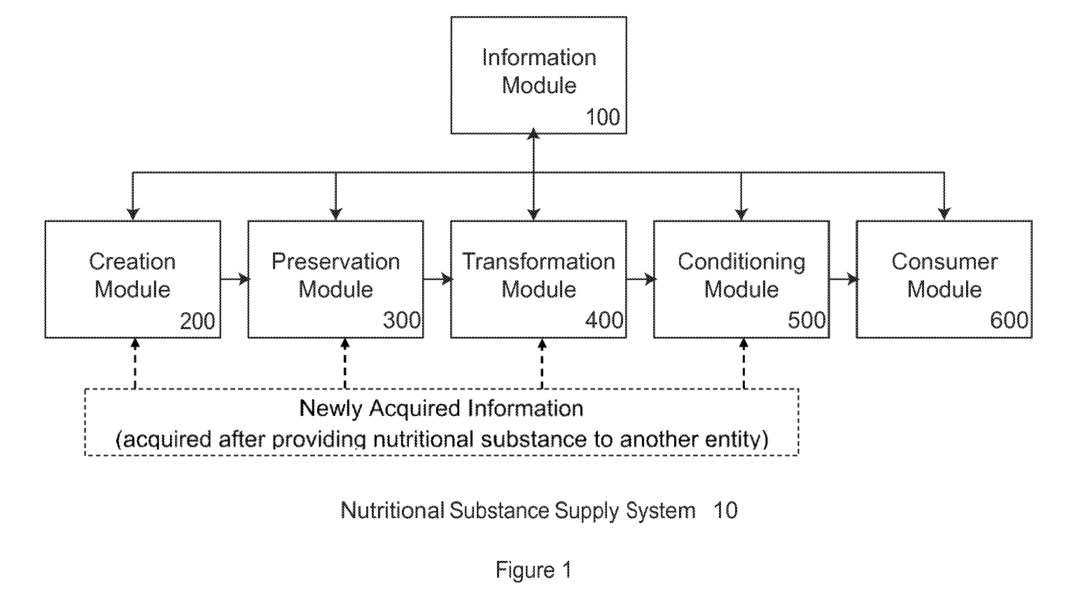

FIG. 1 shows the components of a nutritional substance industry 10. It should be understood that this could be the food and beverage ecosystem for human consumption, but could also be the feed industry for animal consumption, such as the pet food industry. A goal of the present invention for nutritional substance industry 10 is to create, preserve, transform and trace change in nutritional, organoleptic and/or aesthetic values of nutritional substances, collectively and individually also referred to herein as ΔN, through their creation, preservation, transformation, conditioning and consumption. While the nutritional substance industry 10 can be composed of many companies or businesses, it can also be integrated into combinations of business serving many roles, or can be one business or even individual. Since ΔN is a measure of the change in a value of a nutritional substance, knowledge of a prior value (or state) of a nutritional substance and the ΔN value will provide knowledge of the changed value (or state) of a nutritional substance, and can further provide the ability to estimate a change in value (or state).

Module 200 is the creation module. This can be a system, organization, or individual which creates and/or originates nutritional substances. Examples of this module include a farm which grows produce; a ranch which raises beef; an aquaculture farm for growing shrimp; a factory that synthesizes nutritional compounds; a collector of wild truffles; or a deep sea crab trawler.

Preservation module 300 is a preservation system for preserving and protecting the nutritional substances created by creation module 200. Once the nutritional substance has been created, generally, it will need to be packaged in some manner for its transition to other modules in the nutritional substances industry 10. While preservation module 300 is shown in a particular position in the nutritional substance industry 10, following the creation module 200, it should be understood that the preservation module 300 actually can be placed anywhere nutritional substances need to be preserved during their transition from creation to consumption.

Transformation module 400 is a nutritional substance processing system, such as a manufacturer who processes raw materials such as grains into breakfast cereals. Transformation module 400 could also be a ready-to-eat dinner manufacturer who receives the components, or ingredients, also referred to herein as component nutritional substances, for a ready-to-eat dinner from preservation module 300 and prepares them into a frozen dinner. While transformation module 400 is depicted as one module, it will be understood that nutritional substances may be transformed by a number of transformation modules 400 on their path to consumption.

Conditioning module 500 is a consumer preparation system for preparing the nutritional substance immediately before consumption by the consumer. Conditioning module 500 can be a microwave oven, a blender, a toaster, a convection oven, a cook, etc. It can also be systems used by commercial establishments to prepare nutritional substance for consumers such as a restaurant, an espresso maker, pizza oven, and other devices located at businesses which provide nutritional substances to consumers. Such nutritional substances could be for consumption at the business or for the consumer to take out from the business. Conditioning module 500 can also be a combination of any of these devices used to prepare nutritional substances for consumption by consumers.

Consumer module 600 collects information from the living entity which consumes the nutritional substance which has passed through the various modules from creation to consumption. The consumer can be a human being, but could also be an animal, such as pets, zoo animals and livestock, which are they themselves nutritional substances for other consumption chains. Consumers could also be plant life which consumes nutritional substances to grow.

Information module 100 receives and transmits information regarding a nutritional substance between each of the modules in the nutritional substance industry 10 including, the creation module 200, the preservation module 300, the transformation module 400, the conditioning module 500, and the consumer module 600. The nutritional substance information module 100 can be an interconnecting information transmission system which allows the transmission of information between various modules. Information module 100 contains a database, also referred to herein as a dynamic nutritional value database, where the information regarding the nutritional substance resides. Information module 100 can be connected to the other modules by a variety of communication systems, such as paper, computer networks, the internet and telecommunication systems, such as wireless telecommunication systems. In a system capable of receiving and processing real time consumer feedback and updates regarding changes in the nutritional, organoleptic, and/or aesthetic value of nutritional substances, or ΔN, consumers can even play a role in updating a dynamic nutritional value database with observed or measured information about the nutritional substances they have purchased and/or prepared for consumption, so that the information is available and useful to others in the nutritional substance supply system, such as through reports reflecting the consumer input or through modification of ΔN. In a system capable of receiving and processing, creator, preserver, transformer, or conditioner updates regarding a ΔN or other attribute of a nutritional substance they have created or processed, the creator, preserver, transformer, or conditioner can play a role in revising a dynamic nutritional value database with observed or measured or newly acquired information about the nutritional substances they have previously created or processed, so that the revised information is available and useful to others in the nutritional substance supply system, such as through reports reflecting such input or through modification of ΔN.

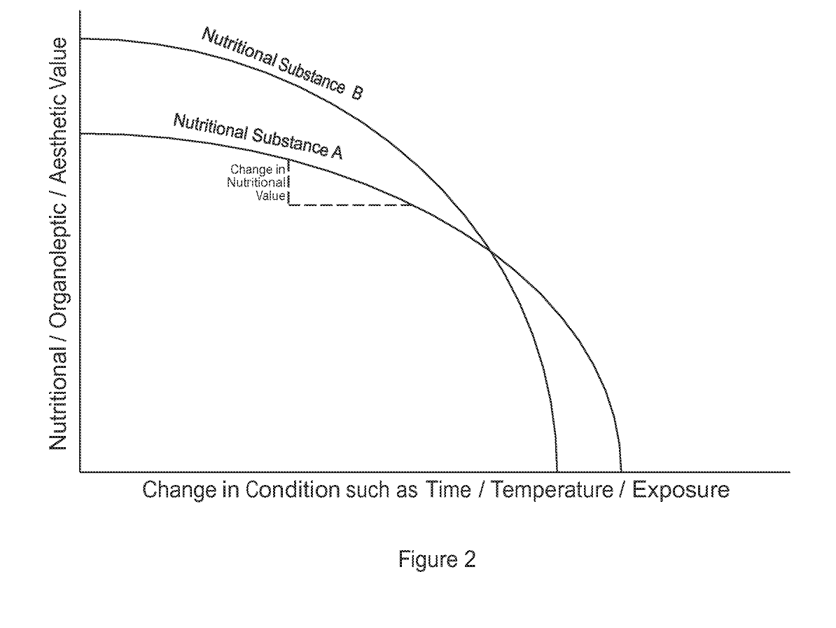

FIG. 2 is a graph showing the function of how a nutritional, organoleptic, or aesthetic value of a nutritional substance varies over the change in a condition of the nutritional substance. Plotted on the vertical axis of this graph can be either the nutritional value, organoleptic value, or even the aesthetic value of a nutritional substance. Plotted on the horizontal axis can be the change in condition of the nutritional substance, ΔN, over a variable such as time, temperature, location, and/or exposure to environmental conditions. This exposure to environmental conditions can include: exposure to air, including the air pressure and partial pressures of oxygen, carbon dioxide, water, or ozone; airborne chemicals, pollutants, allergens, dust, smoke, carcinogens, radioactive isotopes, or combustion byproducts; exposure to moisture; exposure to energy such as mechanical impact, mechanical vibration, irradiation, heat, or sunlight; or exposure to materials such as packaging. The function plotted as nutritional substance A could show a ΔN for milk, such as the degradation of a nutritional value of milk over time. Any point on this curve can be compared to another point to measure and/or describe the change in nutritional value, or the ΔN of nutritional substance A. The plot of the degradation in the same nutritional value of nutritional substance B, also milk, describes the change in nutritional value, or the ΔN of nutritional substance B, a nutritional substance which starts out with a higher nutritional value than nutritional substance A, but degrades over time more quickly than nutritional substance A.

In this example, where nutritional substance A and nutritional substance B are milk, this ΔN information regarding the nutritional substance degradation profile of each milk could be used by the consumer in the selection and/or consumption of the milk. If the consumer has this information at time zero when selecting a milk product for purchase, the consumer could consider when the consumer plans to consume the milk, whether that is on one occasion or multiple occasions. For example, if the consumer planned to consume the milk prior to the point when the curve represented by nutritional substance B crosses the curve represented by nutritional substance A, then the consumer should choose the milk represented by nutritional substance B because it has a higher nutritional value until it crosses the curve represented by nutritional substance A. However, if the consumer expects to consume at least some of the milk at a point in time after the time when the curve represented by nutritional substance B crosses the curve represented by nutritional substance A, then the consumer might choose to select the milk represented by the nutritional substance A, even though milk represented by nutritional substance A has a lower nutritional value than the milk represented by nutritional substance B at an earlier time. This change to a desired nutritional value in a nutritional substance, ΔN, over a change in a condition of the nutritional substance described in FIG. 2 can be measured and controlled throughout nutritional substance supply system 10 in FIG. 1. This example demonstrates how dynamically generated information regarding a ΔN of a nutritional substance, in this case a change in nutritional value of milk, can be used to understand a rate at which that nutritional value changes or degrades; when that nutritional value expires; and a residual nutritional value of the nutritional substance over a change in a condition of the nutritional substance, in this example a change in time. This ΔN information could further be used to determine a best consumption date for nutritional substance A and B, which could be different from each other depending upon the dynamically generated information generated for each.

In FIG. 1, Creation module 200 can dynamically encode nutritional substances to enable the tracking of changes in nutritional, organoleptic, and/or aesthetic value of the nutritional substance, or ΔN. This dynamic encoding, also referred to herein as a dynamic information identifier, can replace and/or complement existing nutritional substance marking systems such as barcodes, labels, and/or ink markings. This dynamic encoding, or dynamic information identifier, can be used to make nutritional substance information from creation module 200 available to information module 100 for use by preservation module 300, transformation module 400, conditioning module 500, and/or consumption module 600, which includes the ultimate consumer of the nutritional substance. One method of marking the nutritional substance with a dynamic information identifier by creation module 200, or any other module in nutritional supply system 10, could include an electronic tagging system, such as the tagging system manufactured by Kovio of San Jose, Calif., USA. Such thin film chips can be used not only for tracking nutritional substances, by can include components to measure attributes of nutritional substances, and record and transmit such information. Such information may be readable by a reader including a satellite-based system. Such a satellite-based nutritional substance information tracking system could comprise a network of satellites with coverage of some or all the surface of the earth, so as to allow the dynamic nutritional value database of information module 100 real time, or near real time updates about a ΔN of a particular nutritional substance.

A method of marking the nutritional substance with a dynamic information identifier, by creation module 200, or any other module in nutritional supply system 10, could include providing an actual printed alphanumeric code on the nutritional substance that can be scanned, such as by a smartphone with a camera running an application for reading alphanumeric characters, or might be manually entered by any member of the nutritional substance supply system. Another method of marking the nutritional substance with a dynamic information identifier by creation module 200 or any other module in nutritional supply system 10, could include providing the nutritional substance with a barcode allowing retrieval of the dynamic information identifier using an appropriate barcode scanner, such as a smartphone with a camera running an application for reading barcode. Another method of marking the nutritional substance with a dynamic information identifier, by creation module 200, or any other module in nutritional supply system 10, could include providing the nutritional substance with an RF tag allowing retrieval of the dynamic information identifier using an appropriate RF scanner. Still another method of marking the nutritional substance with a dynamic information identifier, by creation module 200, or any other module in nutritional supply system 10, could include providing the nutritional substance with a printed QR code (Quick Response Code) allowing retrieval of the dynamic information identifier using an appropriate QR code scanner, such as a smartphone with a camera running an application for reading QR code.

QR codes offer several advantages over other marking methodologies. QR codes are currently utilized by many consumers, using their smartphones, to hardlink to a target website through a URL (Uniform Resource Locator) stored on the QR code. This type of hardlinking is also known as object hyperlinking QR codes are simple to generate, inexpensive printed labels with sufficient storage capacity to store a dynamic information identifier and to store a URL to information module 100. QR codes can be provided on nutritional substances, by any member of the nutritional substance supply system, to include the nutritional substance dynamic information identifier and a URL to hardlink any member of the nutritional substance supply system to information module 100. Using a smart phone any member of the nutritional substance supply system can scan a nutritional substance and automatically be linked to information module 100 to retrieve creation, origin, and ΔN information regarding the scanned nutritional substance. QR codes are a cost effective, readily adopted, provider-friendly, and user-friendly way to mark nutritional substances according to the present invention.

Preservation module 300 includes packers and shippers of nutritional substances. The tracking of changes in nutritional, organoleptic, and/or aesthetic values, or a ΔN, during the preservation period within preservation module 300 allows for dynamic expiration dates for nutritional substances. For example, expiration dates for dairy products are currently based generally only on time using assumptions regarding minimal conditions at which dairy products are maintained. This extrapolated expiration date is based on a worst-case scenario for when the product becomes unsafe to consume during the preservation period. In reality, the degradation of dairy products may be significantly less than this worst-case. If preservation module 300 could measure or derive the actual degradation information such as ΔN, an actual expiration date, referred to herein as a dynamic expiration date, can be determined dynamically, and could be significantly later in time than an extrapolated expiration date. This would allow the nutritional substance supply system to dispose of fewer products due to expiration dates. This ability to dynamically generate expiration dates for nutritional substances is of particular significance when nutritional substances contain few or no preservatives. Such products are highly valued throughout nutritional substance supply system 10, including consumers who are willing to pay a premium for nutritional substances with few or no preservatives.

It should be noted that a dynamic expiration date need not be indicated numerically (i.e., as a numerical date) but could be indicated symbolically as by the use of colors—such as green, yellow and red employed on semaphores—or other designations. In those instances, the dynamic expiration date would not be interpreted literally but, rather, as a dynamically-determined advisory date. In practice a dynamic expiration date will be provided for at least one component of a single or multi-component nutritional substance. For multi-component nutritional substances, the dynamic expiration date could be interpreted as a “best” date for consumption for particular components.

By law, in many localities, food processors such as those in transformation module 400 are required to provide nutritional substance information regarding their products. Often, this information takes the form of a nutritional table applied to the packaging of the nutritional substance. Currently, the information in this nutritional table is based on averages or minimums for their typical product. Using the nutritional substance information from information module 100 provided by creation module 200, preservation module 300, and/or information from the transformation of the nutritional substance by transformation module 400, the food processor could include a dynamically generated nutritional value table, also referred to herein as a dynamic nutritional value table, for the actual nutritional substance being supplied. The information in such a dynamic nutritional value table could be used by conditioning module 500 in the preparation of the nutritional substance, and/or used by consumption module 600, so as to allow the ultimate consumer the ability to select the most desirable nutritional substance which meets their needs, and/or to track information regarding nutritional substances consumed.

Information about changes in nutritional, organoleptic, and/or aesthetic values of nutritional substances, or ΔN, is particularly useful in the conditioning module 500 of the present invention, as it allows knowing, or estimating, the pre-conditioning state of the nutritional, organoleptic, and/or aesthetic values of the nutritional substance, and allows for estimation of a ΔN associated with proposed conditioning parameters. The conditioning module 500 can therefore create conditioning parameters, such as by modifying existing or baseline conditioning parameters, to deliver desired nutritional, organoleptic, and/or aesthetic values after conditioning. The pre-conditioning state of the nutritional, organoleptic, and/or aesthetic value of a nutritional substance is not tracked or provided to the consumer by existing conditioners, nor is the ΔN expected from a proposed conditioning tracked or provided to the consumer either before or after conditioning. However, using information provided by information module 100 from creation module 200, preservation module 300, transformation module 400, and/or information measured or generated by conditioning module 500, conditioning module 500 could provide the consumer with the actual, and/or estimated change in nutritional, organoleptic, and/or aesthetic values of the nutritional substance, or ΔN. Further, consumer feedback and updates regarding observed or measured changes in the nutritional, organoleptic, and/or aesthetic value of nutritional substances, or ΔN, can play a role in updating a dynamic nutritional value database with information about the nutritional substances consumers have purchased and/or prepared for consumption, so that the information is available and useful to others in the nutritional substance supply system, such as through reports reflecting the consumer input or through modification of ΔN. Such information regarding the change to nutritional, organoleptic and/or aesthetic value of the nutritional substance, or ΔN, could be provided not only to the consumer, but could also be provided to information module 100 for use by creation module 200, preservation module 300, transformation module 400, so as to track, and possibly improve nutritional substances throughout the entire nutritional substance supply system 10.

The information regarding nutritional substances provided by information module 100 to consumption module 600 can replace or complement existing information sources such as recipe books, food databases like www.epicurious.com, and Epicurious apps. Through the use of specific information regarding a nutritional substance from information module 100, consumers can use consumption module 600 to select nutritional substances according to nutritional, organoleptic, and/or aesthetic values. This will further allow consumers to make informed decisions regarding nutritional substance additives, preservatives, genetic modifications, origins, traceability, and other nutritional substance attributes that may also be tracked through the information module 100. This information can be provided by consumption module 600 through personal computers, laptop computers, tablet computers, and/or smartphones. Software running on these devices can include dedicated computer programs, modules within general programs, and/or smartphone apps. An example of such a smartphone app regarding nutritional substances is the iOS ShopNoGMO from the Institute for Responsible Technology. This iPhone app allows consumers access to information regarding non-genetically modified organisms they may select. Additionally, consumption module 600 may provide information for the consumer to operate conditioning module 500 in such a manner as to optimize nutritional, organoleptic, and/or aesthetic values of a nutritional substance and/or component nutritional substances thereof according to the consumer's needs or preference, and/or minimize degradation of, preserve, or improve nutritional, organoleptic, and/or aesthetic value of a nutritional substance and/or component nutritional substances thereof.

Through the use of nutritional substance information available from information module 100 nutritional substance supply system 10 can track nutritional, organoleptic, and/or aesthetic value. Using this information, nutritional substances travelling through nutritional substance supply system 10 can be dynamically valued and priced according to nutritional, organoleptic, and/or aesthetic values. For example, nutritional substances with longer dynamic expiration dates (longer shelf life) may be more highly valued than nutritional substances with shorter expiration dates. Additionally, nutritional substances with higher nutritional, organoleptic, and/or aesthetic values may be more highly valued, not just by the consumer, but also by each entity within nutritional substance supply system 10. This is because each entity will want to start with a nutritional substance with higher nutritional, organoleptic, and/or aesthetic value before it performs its function and passes the nutritional substance along to the next entity. Therefore, both the starting nutritional, organoleptic, and/or aesthetic value and the ΔN associated with those values are important factors in determining or estimating an actual, or residual, nutritional, organoleptic, and/or aesthetic value of a nutritional substance, and accordingly are important factors in establishing dynamically valued and priced nutritional substances.

During the period of implementation of the present inventions, there will be nutritional substances being marketed including those benefiting from the tracking of dynamic nutritional information such as ΔN, also referred to herein as information-enabled nutritional substances, and nutritional substances which do not benefit from the tracking of dynamic nutritional information such as ΔN, which are not information enabled and are referred to herein as dumb nutritional substances. Information-enabled nutritional substances would be available in virtual internet marketplaces, as well as traditional marketplaces. Because of information provided by information-enabled nutritional substances, entities within the nutritional substance supply system 10, including consumers, would be able to review and select information-enabled nutritional substances for purchase. It should be expected that, initially, the information-enabled nutritional substances would enjoy a higher market value and price than dumb nutritional substances. However, as information-enabled nutritional substances become more the norm, the cost savings from less waste due to degradation of information-enabled nutritional substances could lead to their price actually becoming less than dumb nutritional substances.

For example, the producer of a ready-to-eat dinner would prefer to use corn of a high nutritional, organoleptic, and/or aesthetic value in the production of its product, the ready-to-eat dinner, so as to produce a premium product of high nutritional, organoleptic, and/or aesthetic value. Depending upon the levels of the nutritional, organoleptic, and/or aesthetic values, the ready-to-eat dinner producer may be able to charge a premium price and/or differentiate its product from that of other producers. When selecting the corn to be used in the ready-to-eat dinner, the producer will seek corn of high nutritional, organoleptic, and/or aesthetic value from preservation module 300 that meets its requirements for nutritional, organoleptic, and/or aesthetic value. The packager/shipper of preservation module 300 would also be able to charge a premium for corn which has high nutritional, organoleptic, and/or aesthetic values. And finally, the packager/shipper of preservation module 300 will select corn of high nutritional, organoleptic, and/or aesthetic value from the grower of creation module 200, who will also be able to charge a premium for corn of high nutritional, organoleptic, and/or aesthetic values.

The change to nutritional, organoleptic, and/or aesthetic value for a nutritional substance, or ΔN, tracked through nutritional substance supply system 10 through nutritional substance information from information module 100 can be preferably determined from measured information. However, some or all such nutritional substance ΔN information may be derived through measurements of environmental conditions of the nutritional substance as it travelled through nutritional substance supply system 10. Additionally, some or all of the nutritional substance ΔN information can be derived from ΔN data of other nutritional substances which have travelled through nutritional substance supply system 10. Nutritional substance ΔN information can also be derived from laboratory experiments performed on other nutritional substances, which may approximate conditions and/or processes to which the actual nutritional substance has been exposed. Further, consumer feedback and updates regarding observed or measured changes in the nutritional, organoleptic, and/or aesthetic value of nutritional substances can play a role in updating ΔN information. Also, a creator, preserver, transformer, or conditioner may revise ΔN information, or information regarding other attributes of nutritional substances they have previously created or processed, based upon newly acquired information affecting the ΔN or the other attributes.

For example, laboratory experiments can be performed on bananas to determine effect on or change in nutritional, organoleptic, and/or aesthetic value, or ΔN, for a variety of environmental conditions bananas may be exposed to during packaging and shipment in preservation module 300. Using this experimental data, tables and/or algorithms could be developed which would predict the level of change of nutritional, organoleptic, and/or aesthetic values, or ΔN, for a particular banana based upon information collected regarding the environmental conditions to which the banana was exposed during its time in preservation module 300. While the ultimate goal for nutritional substance supply system 10 would be the actual measurement of nutritional, organoleptic, and/or aesthetic values to determine ΔN, use of derived nutritional, organoleptic, and/or aesthetic values from experimental data to determine ΔN would allow improved logistics planning because it provides the ability to prospectively estimate changes to nutritional, organoleptic, and/or aesthetic values, or ΔN, and because it allows more accurate tracking of changes to nutritional, organoleptic, and/or aesthetic values, or ΔN, while technology and systems are put in place to allow actual measurement.

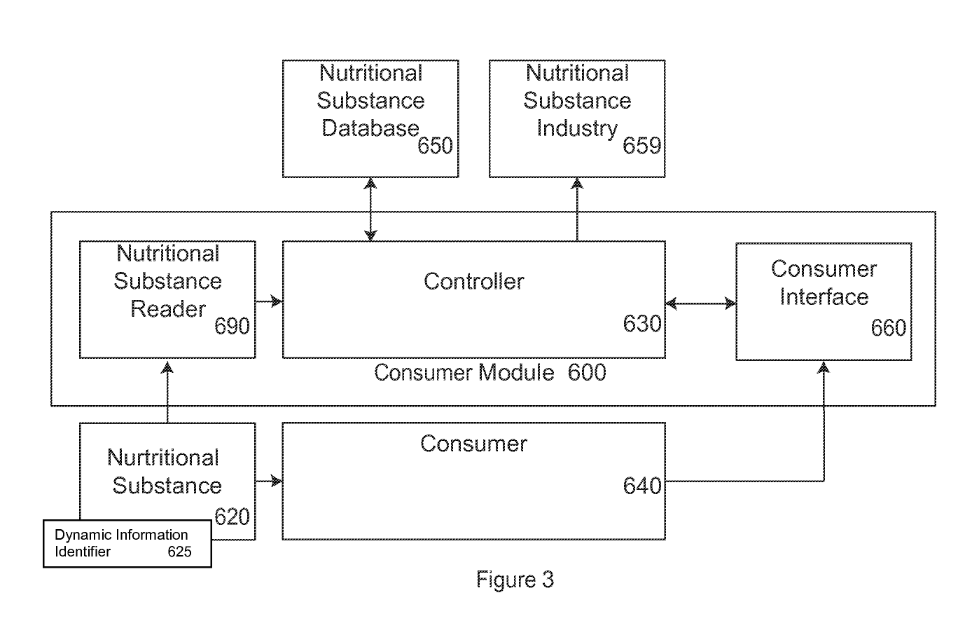

FIG. 3 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information regarding nutritional substance 620 allowing retrieval of information regarding nutritional substance 620 and provides it to controller 630. The reference information regarding the nutritional substance is a dynamic information identifier 625 provided with and/or associated with the nutritional substance 620. Nutritional substance reader 690 provides such reference information, the dynamic information identifier 625, to controller 630. Nutritional substance 620 is consumed by consumer 640. Prior to, during, and/or following, consumption of nutritional substance 620 consumer 640 provides information to consumer interface 660. Such information is provided by consumer interface 660 to controller 630. Controller 630 correlates the nutritional substance information and/or the dynamic information identifier 625 and/or the consumer information and provides the correlated information to nutritional substance industry 659. Such information may be used for improving nutritional substance 620, creating new nutritional substances, discontinuing nutritional substances, and for marketing nutritional substance 620. Other uses of such correlated consumer information will be apparent to those in the nutritional substance industry 659. In a further embodiment described herein, consumer information may also be provided to the nutritional substance industry 659. In an additional embodiment, such consumer provided information is related to the nutritional, organoleptic, and/or aesthetic value of the nutritional substance before or after conditioning, and is available for updating a dynamic nutritional value dataset within the nutritional substance database 650 associated with the dynamic information identifier 625. In this case, the consumer contributes input to the dynamic nutritional substance information available for the nutritional substances they purchase and consume.

In an alternate embodiment, controller 630 references dynamic information identifier 625 for nutritional substance 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620.

Consumer module 600 can be implemented with discreet devices. For example, nutritional substance reader 690 could be an optical reader such as a barcode scanner or camera capable of discerning reference information, such as a dynamic information identifier. Preferably, nutritional substance reader 690 could be an optical reader such as a QR code scanner or camera capable of discerning reference information, such as a dynamic information identifier, and capable of discerning a URL to hardlink a user to information module 100. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630. Nutritional substance reader 690 may also be integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620, and if desired, to a known nutritional substance dynamic information identifier 625.

In operation, consumer 640 would use the camera on the tablet computer or smartphone to read a barcode or QR code on nutritional substance 620 providing the reference information or dynamic information identifier 625 for nutritional substance 620. The tablet computer or smartphone would display an appropriate user interface so as to allow consumer 640 to provide information about her consumption of nutritional substance 620. Controller 630 could query nutritional substance database 650 using dynamic information identifier 625 regarding nutritional substance 620 to determine those in the nutritional substance industry who were involved in the supply chain for nutritional substance 620 or to determine a current and/or post conditioning nutritional, organoleptic, and/or aesthetic value of the nutritional substance. Additionally, nutritional substance database 650 could contain information on what information to collect from consumer 640 of the particular nutritional substance 620 being referenced. The tablet computer or smartphone could then display an appropriate user interface so as to allow consumer 640 to provide information about the nutritional, organoleptic, and/or aesthetic values of the nutritional substance 620.

Such information could be provided through a connection to the internet accessed through the telecommunication system in the tablet computer or smartphone. Preferably, such a telecommunications connection to nutritional substance database 650 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

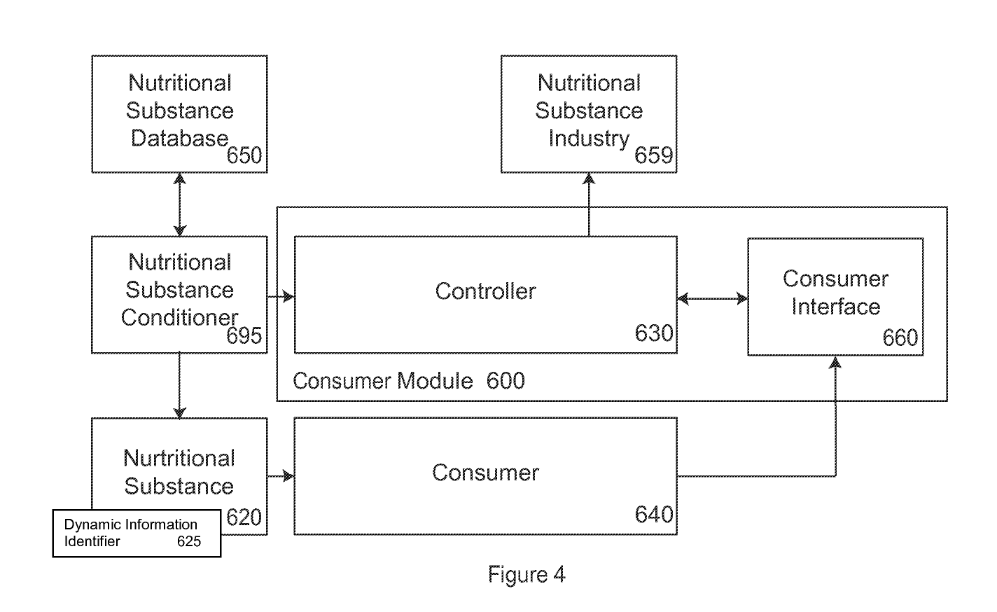

FIG. 4 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695 and dynamic information identifier 625.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the dynamic information identifier 625, such as from a reference tag on nutritional substance 620, the ready-to-eat dinner. Using the dynamic information identifier 625, nutritional substance conditioner 695 receives, from nutritional substance database 650, information regarding nutritional substance 620, the ready-to-eat dinner. In this case, if the nutritional substance conditioner 695 is a nutritional substance information ready microwave oven, that is, it is capable of processing information enabled nutritional substances, it would obtain from nutritional substance database 650 preparation information, organoleptic information, and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-eat dinner. Such information may include consumer feedback, observations, or measurements regarding the nutritional, organoleptic, and/or aesthetic value of the nutritional substance before or after conditioning.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620. Such information could even be available to other consumers of the nutritional substance through nutritional substance industry 659 or nutritional substance database 650.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

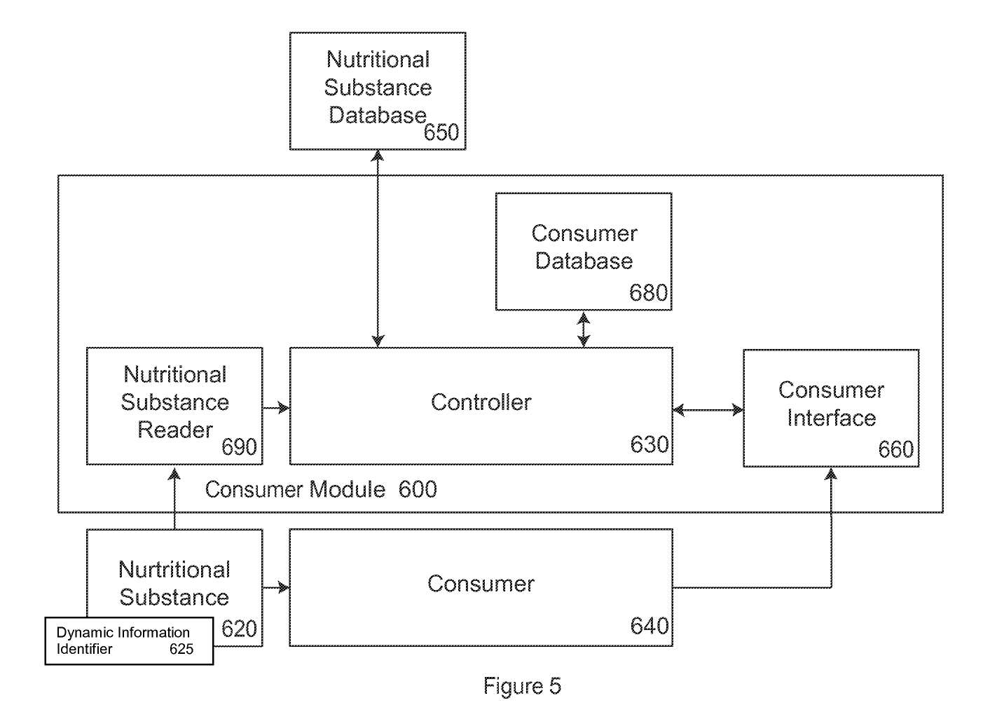

FIG. 5 shows an embodiment of consumer module 600 of the present invention. In a first embodiment of the present invention, consumer module 600 comprises nutritional substance reader 690, controller 630, and consumer interface 660. A nutritional substance 620 is read by nutritional substance reader 690 to obtain reference information regarding nutritional substance 620 in the form of a dynamic information identifier 625. Nutritional substance reader 690 provides the dynamic information identifier 625 to controller 630. Nutritional substance 620 is consumed by consumer 640. Prior to, during, and/or following, consumption of nutritional substance 620 consumer 640 provides information to consumer interface 660. Such information is provided by consumer interface 660 to controller 630. Controller 630 correlates the nutritional substance information and/or the dynamic information identifier and the consumer information and provides the correlated information to nutritional substance database 650. Such information may be used for improving nutritional substance 620, creating new nutritional substances, discontinue nutritional substances, and for marketing nutritional substance 620. Other uses of such correlated consumer information will be apparent to those in the nutritional substance industry 659. In a further embodiment described herein, consumer information may also be provided to the nutritional substance industry 659. In an additional embodiment, consumer provided information is related to the nutritional, organoleptic, and/or aesthetic value of the nutritional substance before or after conditioning, and is available for updating a dynamic nutritional value dataset within the nutritional substance database 650 associated with the dynamic information identifier 625. In this case, the consumer contributes input to the dynamic nutritional substance information available for the nutritional substances they purchase and consume.

In an alternate embodiment, controller 630 references dynamic information identifier 625 for nutritional substance 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the supply chain of nutritional substance 620 or may make consumer information available to other consumers of the nutritional substance.

Also included in consumer module 600 is consumer database 680. Consumer database 680 contains specific information regarding consumer 640. Correlated information regarding the consumption of nutritional substance 620 could be stored for future reference in consumer database 680 and is preferably correlated with the dynamic information identifier 625. Such information could be used in collecting future consumer information. For example, if consumer 640 is very particular about a certain aspect of a nutritional substance 620, controller 630 could ask for additional and/or more specific information from consumer 640 about the nutritional substance 620 through consumer interface 660. As an example, consumer 640 is very particular about the texture of pasta. When nutritional substance 620 being consumed by consumer 640 contains pasta, controller 630, in response to historical consumer 640 information in consumer database 680, could ask for additional information regarding the texture of the pasta in nutritional substance 620, using consumer interface 660. In this case, the consumer contributes valuable input to the dynamic nutritional substance information available for the nutritional substances they purchase and consume.

Consumer module 600 can be implemented with discreet devices. For example, nutritional substance reader 690 could be an optical reader such as a barcode scanner or camera capable of discerning reference information, such as a dynamic information identifier. Preferably, nutritional substance reader 690 could be an optical reader such as a QR code scanner or camera capable of discerning reference information, such as a dynamic information identifier, and capable of discerning a URL to hardlink a user to information module 100. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630. Nutritional substance reader 690 may also be integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620 and if desired, to a known nutritional substance dynamic information identifier 625.

In operation, consumer 640 would use the camera on the tablet computer or smartphone to read a barcode or QR code on nutritional substance 620 providing the reference information or dynamic information identifier 625 for nutritional substance 620. The tablet computer or smartphone would display an appropriate user interface so as to allow consumer 640 to provide information about her consumption of nutritional substance 620. Controller 630 could query nutritional substance database 650 using dynamic information identifier 625 regarding nutritional substance 620 to determine those in the nutritional substance industry who were involved in the supply chain for nutritional substance 620 or to determine a current and/or post conditioning nutritional, organoleptic, and/or aesthetic value of the nutritional substance. Additionally, nutritional substance database 650 could contain information on what information to collect from consumer 640 of the particular nutritional substance 620 being referenced. The tablet computer or smartphone could then display an appropriate user interface so as to allow consumer 640 to provide information about the nutritional, organoleptic, and/or aesthetic values of the nutritional substance 620.

Such information could be provided through a connection to the internet accessed through the telecommunication system in the tablet computer or smartphone. Preferably, such a telecommunications connection to nutritional substance database 650 would be a wireless telecommunication system. The tablet computer or smartphone would then, in the same manner, provide the consumer information regarding her consumption of nutritional substance 620 to those in nutritional substance industry 659 involved in the supply chain of nutritional substance 620.

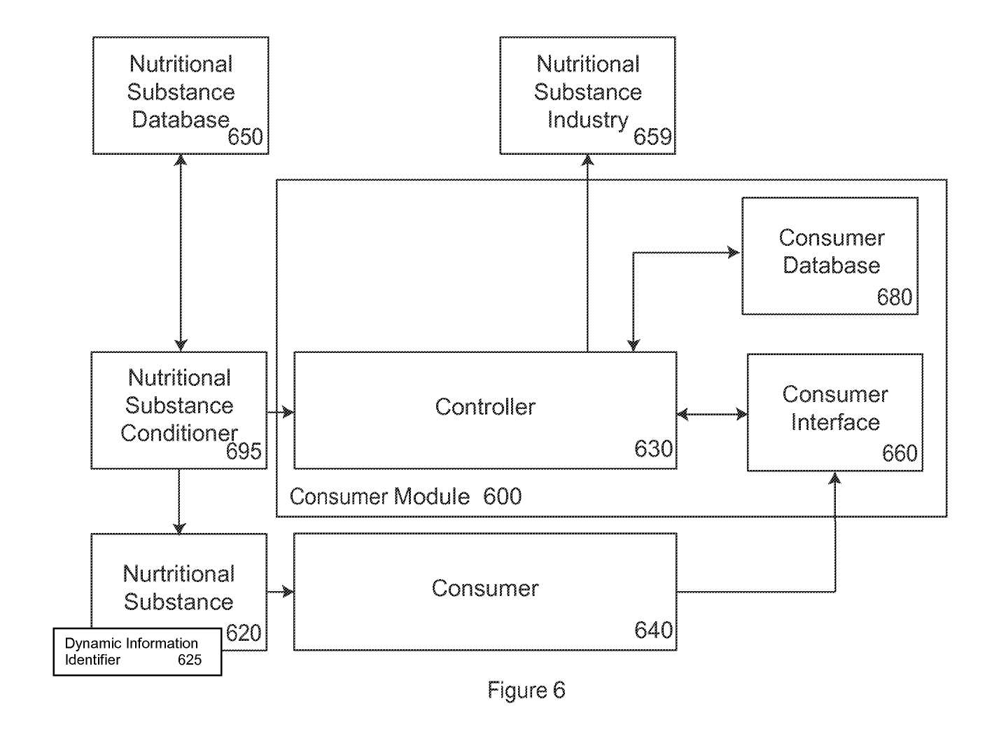

FIG. 6 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695 and dynamic information identifier 625.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the dynamic information identifier 625, such as from a reference tag on nutritional substance 620, the ready-to-eat dinner. Using the dynamic information identifier 625, nutritional substance conditioner 695 receives, from nutritional substance database 650, information regarding nutritional substance 620, the ready-to-eat dinner. In this case, if the nutritional substance conditioner 695 is a nutritional substance information ready microwave oven, that is, it is capable of processing information enabled nutritional substances, it would obtain from nutritional substance database 650 preparation information, aesthetic information and/or organoleptic information and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner. Such information may include consumer feedback, observations, or measurements regarding the nutritional, organoleptic, and/or aesthetic value of the nutritional substance before or after conditioning.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620. Such information could even be available to other consumers of the nutritional substance through nutritional substance database 650 or consumer database 680.

In this embodiment, consumer module 600 could be part of nutritional substance conditioner 695. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

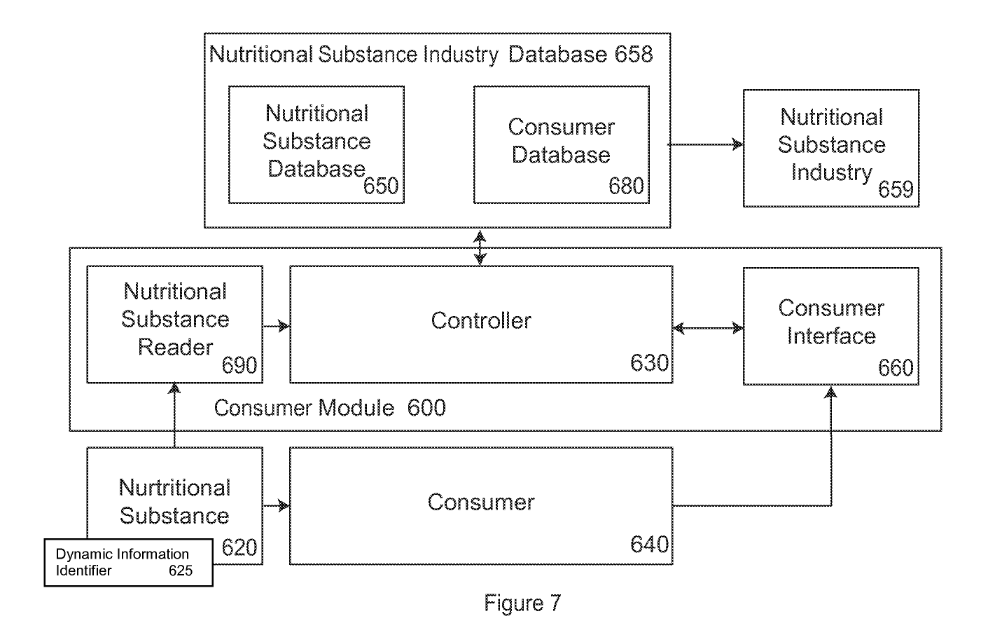

FIG. 7 shows an embodiment of consumer module 600 of the present invention. In the first embodiment of the present invention, consumer module 600 comprises nutritional substance reader 690, controller 630, and consumer interface 660. A nutritional substance 620 is read by nutritional substance reader 690 to obtain reference information in the form of a dynamic information identifier 625 regarding nutritional substance 620. Nutritional substance reader 690 provides the dynamic information identifier 625 to controller 630. Nutritional substance 620 is consumed by consumer 640. Prior to, during, and/or following, consumption of nutritional substance 620 consumer 640 provides information to consumer interface 660. Such information is provided by consumer interface 660 to controller 630. Controller 630 correlates the nutritional substance information and/or the dynamic information identifier and the consumer information and provides the correlated information to nutritional substance industry database 658, which can include nutritional substance database 650 and/or consumer database 680. Such information may be used for improving nutritional substance 620, creating new nutritional substances, discontinuing nutritional substances, and for marketing nutritional substance 620. Other uses of such correlated consumer information will be apparent to those in the nutritional substance industry 659. In a further embodiment described herein, consumer information may also be provided to the nutritional substance industry 659. In an additional embodiment, consumer provided information is related to the nutritional, organoleptic, and/or aesthetic value of the nutritional substance before or after conditioning, and is available for updating a dynamic nutritional value dataset within the nutritional substance database 650 associated with the dynamic information identifier 625. In this case, the consumer contributes input to the dynamic nutritional substance information available for the nutritional substances they purchase and consume.

In an alternate embodiment, controller 630 references dynamic information identifier 625 for nutritional substance 620 to nutritional substance database 650 to determine those in nutritional substance industry 659 who were involved in the creation, preserving, transforming, and/or conditioning of the nutritional substance 620. Controller 630 may provide the consumer information regarding nutritional substance 620 to those involved in the nutritional substance industry 659 or may make consumer information available to other consumers of the nutritional substance through the nutritional substance industry database 658.

Included in the nutritional substance industry database is consumer database 680. Consumer database 680 contains specific information regarding consumer 640. Correlated information regarding the consumption of nutritional substance 620 could be stored for future reference in consumer database 680 and is preferably correlated with dynamic information identifier 625. Such information could be used in collecting future consumer information. For example, if consumer 640 is very particular about a certain aspect of a nutritional substance 620, controller 630 could ask for additional and/or more specific information from consumer 640 about the nutritional substance 620 through consumer interface 660. As an example, consumer 640 is very particular about the texture of pasta. When nutritional substance 620 being consumed by consumer 640 contains pasta, controller 630, in response to historical consumer 640 information in consumer database 680, could ask for additional information regarding the texture of the pasta in nutritional substance 620, using consumer interface 660. In this case, the consumer contributes dynamic input to the nutritional substance industry database available for the nutritional substances they purchase and consume.

Consumer module 600 can be implemented with discreet devices. For example, nutritional substance reader 690 could be an optical reader such as a barcode scanner or camera capable of discerning reference information, such as a dynamic information identifier. Preferably, nutritional substance reader 690 could be an optical reader such as a QR code scanner or camera capable of discerning reference information, such as a dynamic information identifier, and capable of discerning a URL to hardlink a user to information module 100. Nutritional substance reader 690 could also be a wireless signal reader, reading RFID labels, or near field IDs. Controller 630 can be a computer, microcontroller, personal computer, laptop computer, tablet computer, or smartphone. Consumer interface 660 can be a standalone touchpad display panel which allows interaction with the consumer, but is preferably integrated into controller 630. Nutritional substance reader 690 may also be integrated into controller 630.

Preferably, consumer module 600 is an integrated device such as a tablet computer or smartphone. In this case, nutritional substance reader 690 could be the camera located on the tablet or smartphone. Consumer interface 660 would be the touchscreen display of the tablet or smartphone. Finally, controller 630 would be the microprocessor in the tablet computer or smartphone. In this embodiment, the software to run consumer module 600 could be an app loaded onto the tablet or smartphone, designed to collect consumer information correlated to a known nutritional substance 620 and if desired, to a known nutritional substance dynamic information identifier 625.

In operation, consumer 640 would use the camera on the tablet computer or smartphone to read a barcode on nutritional substance 620 providing the reference information or dynamic information identifier 625 for nutritional substance 620. The tablet computer or smartphone would display an appropriate user interface so as to allow consumer 640 to provide information about her consumption of nutritional substance 620. Controller 630 could query nutritional substance database 650 using dynamic information identifier 625 regarding nutritional substance 620 to determine those in the nutritional substance industry who were involved in the supply chain for nutritional substance 620 or to determine a current and/or post conditioning nutritional, organoleptic, and/or aesthetic value of the nutritional substance. Additionally, nutritional substance database 650 could contain information on what information to collect from consumer 640 of the particular nutritional substance 620 being referenced. The tablet computer or smartphone could then display an appropriate user interface so as to allow consumer 640 to provide information about the nutritional, organoleptic, and/or aesthetic values of the nutritional substance 620.

Such information could be provided through a connection to the internet accessed through the telecommunication system in the tablet computer or smartphone. Preferably, such a telecommunications connection would be a wireless telecommunication system communicating with nutritional substance industry database 658. The tablet computer or smartphone would then, in the same manner, provide the consumer information regarding her consumption of nutritional substance 620 to the consumer database 680 within the nutritional substance industry database 658, available for use by those in nutritional substance industry 659 involved in the supply chain of nutritional substance 620.

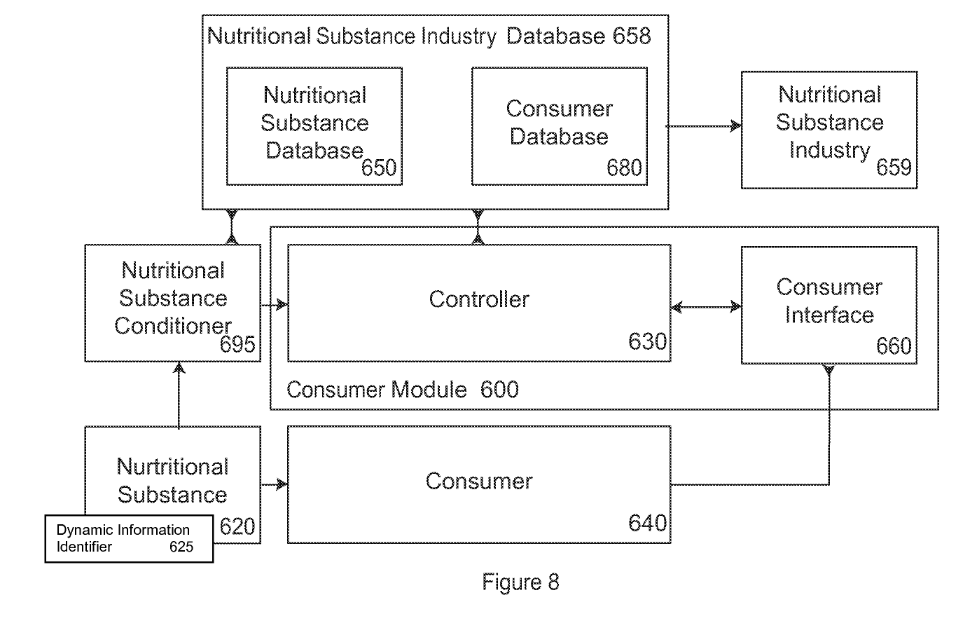

FIG. 8 shows an alternate embodiment of the present invention where nutritional substance 620 was conditioned by nutritional substance conditioner 695. In this case, nutritional substance conditioner 695 would already have information pertaining to nutritional substance 620, including information on how nutritional substance 620 was conditioned by nutritional substance conditioner 695 and dynamic information identifier 625.

In this embodiment, controller 630 receives such information regarding nutritional substance 620 and correlates it with consumer information from consumer interface 660 and provides it to nutritional substance industry 659.

For example, nutritional substance conditioner 695 conditions a ready-to-eat dinner. In the process of conditioning the ready-to-eat dinner, nutritional substance conditioner 695 receives various information, reads the dynamic information identifier 625, such as from a reference tag on nutritional substance 620, the ready-to-eat dinner. Using the dynamic information identifier 625, nutritional substance conditioner 695 receives, from nutritional substance database 650, information regarding nutritional substance 620, the ready-to-eat dinner. In this case, if the nutritional substance conditioner 695 is a nutritional substance information ready microwave oven, that is, it is capable of processing information enabled nutritional substances, it would obtain from nutritional substance database 650 preparation information, aesthetic information and/or organoleptic information and/or nutritional information about the ready-to-eat dinner. Upon presentation of the ready-to-eat dinner to consumer 640, nutritional substance conditioner 695 also provides the information regarding the ready-to-eat dinner it received from nutritional substance database 650 along with information it collected regarding the conditioning of the ready-to-eat dinner by nutritional substance conditioner 695, to controller 630. If consumer module 600 is a standalone device such as a tablet computer or smartphone, the information from nutritional substance conditioner 695 could be transferred by means of a wireless local area network or Bluetooth connection. Consumer module 600, the smartphone for example, would obtain consumer information regarding the consumption of the nutritional substance 620. Since the smartphone knows what was consumed, it can obtain from consumer 640 information appropriate for the ready-to-dinner. Such information may include consumer feedback, observations, or measurements regarding the nutritional, organoleptic, and/or aesthetic value of the nutritional substance before or after conditioning.

In the case of the ready-to-eat dinner, the consumer 640 could be asked specifically about the taste of the corn and the taste of the beef in the dinner, as well as their combination. Using such information and the information from the nutritional substance database 650, consumer module 600 can provide appropriate information to those in the nutritional substance industry 659 who were involved in the supply chain for nutritional substance 620. Such information could even be available to other consumers of the nutritional substance through nutritional substance database 650 or consumer database 680.

In this embodiment, consumer module 600 could be part of a nutritional substance conditioner. In this example, the nutritional substance information ready microwave oven would provide user interface 660 to receive consumer information regarding the nutritional substance 620 conditioned by nutritional substance conditioner 695. In such a case, controller 630 likely would be the same controller which operates nutritional substance conditioner 695.

Included in the nutritional substance industry database 658 is consumer database 680. Consumer database 680 contains specific information regarding consumer 640. Correlated information regarding the consumption of nutritional substance 620 could be stored for future reference in consumer database 680 and is preferably correlated with dynamic information identifier 625. Such information could be used in collecting future consumer information. For example, if consumer 640 is very particular about a certain aspect of a nutritional substance 620, controller 630 could ask for additional and/or more specific information from consumer 640 about the nutritional substance 620 through consumer interface 660. As an example, consumer 640 is very particular about the texture of pasta. When nutritional substance 620 being consumed by consumer 640 contains pasta, controller 630, in response to historical consumer 640 information in consumer database 680, could ask for additional information regarding the texture of the pasta in nutritional substance 620, using consumer interface 660. In this case, the consumer contributes dynamic input to the nutritional substance industry database available for the nutritional substances they purchase and consume.

Controller 630 is connected to nutritional substance industry database 658. Nutritional substance industry database 658 contains information regarding nutritional substances 620 in nutritional substance database 650. Also contained in nutritional substance industry database 658 is consumer database 680 which contains information about consumer 640.

In the preferred embodiment of the present invention, nutritional substance industry database 658 is a massive multi-dimension data base used by part or all of the nutritional substance industry to track, store and analyze information about nutritional substances, changes in nutritional, organoleptic, and/or aesthetic value of nutritional substances (ΔN), preservation of nutritional substances, transformation of nutritional substances, conditioning of nutritional substances, recipes for the preparation of nutritional substances, consumption of nutritional substances, consumer information, and marketing of nutritional substances.

### Examples of the Invention

To illustrate benefits of the present invention the following example is provided of a consumer who is faced with making a purchasing decision based on several variables. A consumer would like to make an Italian entré for dinner on Friday, but must go to the market on Monday (4 days in advance of preparing the entré), and is not sure of an appropriate recipe to meet his unique needs, for example, nutritional substances low in sodium, gluten-free and high in lycopene. The consumer uses his smartphone to: access a nutritional substance information module that has access to a consumer module with the consumer's personal consumer profile, including low sodium, gluten-free and high lycopene preferences, and retrieves appropriate recipes; or alternatively, the consumer might use his smartphone to access various recipe databases for Italian recipes using an application on his smartphone to filter the recipes according to his consumer profile, including low sodium, gluten-free and high lycopene; or alternatively, the consumer might use his smartphone to access a recipe database for Italian recipes wherein the database provides consumer interface through the consumer's smartphone screen to provide input regarding the consumer's needs, such as low sodium, gluten-free and high lycopene. In this way, the consumer obtains a recipe comprising a list of ingredients for an entré that meets his essential health needs, and can capture the recipe. In this case, the consumer has selected a recipe for gluten-free pasta with marinara sauce.

The consumer then uses his smartphone, tablet computer, or personal computer to locate nearby supermarkets and verify if the supermarkets have all of the required ingredients to make the desired gluten-free pasta with marinara sauce, plus other items he needs to purchase, such as a specific bottle of wine and cheese to enjoy with the entré. Unfortunately, all of the ingredients and other items are not available at his preferred supermarket, but he finds that they are available at an alternate supermarket nearby. He is not familiar with the alternate supermarket, and does not know the locations of the various ingredients or the other items in the unfamiliar supermarket, so in order to make his shopping experience more efficient he uses his smartphone, tablet computer, or personal computer to request the location of the ingredients and other items within the supermarket and the fastest route within the supermarket to collect the items on his shopping list. For example, the consumer's smartphone utilizes an application created for the alternate supermarket to identify the location within the alternate supermarket of the various items on his shopping list and generate a route within the alternate supermarket that the consumer can follow that will result in the least amount of time required for collecting the ingredients. The suggested route may instruct that he starts in the produce isle of the supermarket, in this case isle number 1, and provide the list of ingredients to collect at that location. As he collects the various ingredients required from the produce isle, his smartphone can allow him to delete a collected item, change its status to indicate it has been collected, or may allow him to move it from a list of items to be collected to a list of items collected. Upon collecting the last item from the produce isle, the smartphone instructs him to go to the specific isle where the low sodium, gluten-free pasta can be found, which in this case is isle 11. Upon collecting the gluten-free pasta from isle 11, the smartphone instructs him to go to the specific isle where wine is located, which in this case is isle 14. Upon collecting the wine from isle 14, the smartphone instructs him to go to the specific isle where cheese can be found, in this case isle 15. In this way, the consumer's time spent locating and collecting the items required for purchase is minimized because he is able to make one quick pass through the supermarket, visiting only the correct location for each item, and with no backtracking Additionally, his smartphone can easily verify that all required items have been collected. Further, his smartphone can be used to retrieve a dynamic information identifier from each nutritional substance considered for purchase so that he may retrieve related source and ΔN information from a nutritional value database in the nutritional substance information module. Preferably, the nutritional substance is provided with a QR code including the dynamic information identifier and a URL to hardlink the consumer to the nutritional substance information module. The consumer would use his smartphone to scan such a QR code on a nutritional substance of interest. The smartphone would then hardlink the consumer to the nutritional substance information and retrieve source and ΔN information associated with the dynamic information identifier.

If no single supermarket has all of the ingredients and other items are required, the consumer can still retrieve a route requiring the least time to collect the items from multiple supermarkets. For example, if the consumer must visit two supermarkets to collect all items, the route retrieved can include both the driving instructions from the consumer's home to a first supermarket, the route to follow within the first supermarket, driving instructions from the first supermarket to a second supermarket, the route to follow within the second supermarket, and driving instructions from the second supermarket to the consumer's home. Further, his smartphone can be used to retrieve a dynamic information identifier from any nutritional substance provided with a dynamic information identifier so that he may retrieve related source and ΔN information from a dynamic nutritional value database in the nutritional substance information module. Preferably, the nutritional substance is provided with a QR code including the dynamic information identifier and a URL to hardlink the consumer to the nutritional substance information module.

The consumer goes to the supermarket to purchase the ingredients for the desired entré. The consumer is interested in preparing a meal that meets his needs when it is prepared 4 days from the time of purchase. The recipe calls for tomatoes and pasta among the ingredients. The consumer uses his smartphone to scan a dynamic information identifier on Heirloom tomatoes, such as by scanning a QR code including the dynamic information identifier and a URL to hardlink the consumer to the nutritional substance information module, to access the dynamic nutritional value database to verify if the Heirloom tomatoes will meet his needs for high lycopene when prepared in 4 days, and finds that they will not, based upon their current nutritional value and the ΔN associated with 4 days storage at expected storage conditions. The consumer may then use his smartphone to scan a dynamic information identifier on Roma tomatoes, such as by scanning a QR code including the dynamic information identifier and a URL to hardlink the consumer to the nutritional substance information module, to access the dynamic nutritional value database and find that the Roma tomatoes will meet his high lycopene needs when prepared in 4 days from now, based upon their current nutritional value and the ΔN associated with 4 days storage at expected storage conditions, and therefore decides to purchase Roma tomatoes. In a similar fashion, the consumer scans a QR code including a dynamic information identifier and URL for the nutritional substance information module on one or more pasta products, accesses the dynamic nutritional value database and finds out if the products meet, or do not meet, his low sodium and gluten-free needs when prepared in 4 days, and then makes purchasing decisions regarding pasta. The consumer is not the only entity that has benefited from the dynamic nutritional information about the Heirloom tomatoes, the Roma tomatoes and the pasta, as data regarding the consumer's needs for low sodium, gluten-free, and high lycopene have been collected by the consumer module and correlated with the respective dynamic information identifiers, and are available to, such as transmitted to, the information module and are of particular interest and accessible to the growers and packagers of the respective tomatoes and to the transformer of the one or more pastas. The dynamic nutritional value database will also provide ΔN information of how the nutritional values of any other ingredients he is buying will evolve during the next 4 days (tomatoes, pasta, garlic, onions, basil etc. . . . ) if those ingredients are supplied with dynamic information identifiers. This consumer information can be saved and be made available to all other entities in the nutritional substance supply system.

Also, while shopping for the ingredients for the pasta with marinara sauce, the consumer decides to buy a bottle of wine and some cheese to go with the meal. Using his smartphone to read QR codes (providing dynamic information identifiers and URL to the nutritional substance information module) form bottles of wine and cheeses he is considering for purchase, he can retrieve information from the dynamic nutritional value database with his smartphone regarding source and ΔN information of those products, and can make informed decisions on the maturity of nutritional substances that actually discompose to be ready to eat or drink, like the cheese and the bottle of wine, and can now see how good it will be to enjoy it in 4 days.

When the consumer is ready to prepare the recipe for pasta with marinara sauce, he uses his smartphone to read QR codes (providing dynamic information identifiers and URL to the nutritional substance information module) from the tomatoes he has purchased in order to access the nutritional substance information module containing dynamic nutritional values for the tomatoes identified by the specific dynamic information identifier. The nutritional substance information module has source and ΔN information regarding changes in lycopene levels of the tomatoes, and uses that information to modify a conditioning protocol, in this case the conditioning protocol associated with the recipe chosen by the consumer, such that lycopene levels are minimally degraded, maintained, or enhanced, such as by recommending changes to cooking temperature and cooking time. The consumer also uses his smartphone to read QR codes (providing dynamic information identifiers and URL to the nutritional substance information module) from the pasta he has purchased in order to access the nutritional substance information module containing dynamic nutritional values for the pasta identified by the specific dynamic information identifier. The nutritional substance information module has source and ΔN information regarding the pasta. Further, the consumer's preference for al dente texture may be available as part of a consumer specific profile within the consumer module, or may result from a query required by the conditioning protocol, in this case the conditioning protocol associated with the recipe chosen by the consumer, and provided through the consumer's smartphone. The information is used by the nutritional substance information module to modify the conditioning protocol for the pasta, such as by modifying the amount of time in boiling water.

To illustrate other benefits of the present invention, another example is provided of a consumer who is faced with making a consumption decision regarding a nutritional substance he has already purchased. In this example, a consumer has purchased Heirloom tomatoes to make a salad. The consumer knows that Heirloom tomatoes are only ripe for a short time, and does not want them to become overripe before preparing the salad. In this case, knowing a dynamic expiration date, that is, an actual “best use” date, for the tomatoes would be far more valuable than the static expiration information currently available. The consumer could use his smartphone to read a QR code (providing dynamic information identifiers and URL to the nutritional substance information module) from the tomatoes he has purchased, and find that based upon dynamically generated data available through the dynamic nutritional value database in the nutritional substance information module, the tomatoes will become overripe in 1 day. This dynamic expiration information would alert the consumer that the actual “best use” date is close, and he should consider using the tomatoes soon. Here again, the consumer is not the only entity that has benefited from the dynamic nutritional information about the Heirloom tomatoes, as data regarding the consumer's needs for ripened tomatoes have been collected by the consumer module and correlated with the respective dynamic information identifiers, and are available and of particular interest to the growers and packagers of the Heirloom tomatoes.

To illustrate additional benefits of the present invention the following example is provided of a supermarket that is faced with making a purchasing decision regarding a nutritional substance it is considering for purchase. In this example, a supermarket considers the purchase of peaches from two different suppliers. The supermarket knows that peaches are only ripe for a short time, and does not want them to become overripe before sale. In this case, knowing a dynamic expiration date, that is, an actual “best use” date, for the peaches would be far more valuable than static expiration information currently available to the supermarket, and more valuable than simply following FIFO inventory practices. The supermarket could use the dynamic information identifier for the peaches it is contemplating for purchase, such as by scanning a QR code received by facsimile or e-mail or downloaded from the supplier's website, and find that based upon dynamically generated data available through the dynamic nutritional value database in the nutritional substance information module, the peaches from one supplier will become overripe 2 days earlier than their expected sales cycle, while peaches from the other supplier will not become overripe until 2 days past their expected sales cycle, and in addition would find the actual ΔN curve of what it means for the nutritional values when the peaches from both suppliers become overripe. This dynamic expiration information would inform the supermarket's purchasing decision. The dynamic expiration information would further inform the supermarket's pricing strategy. For example, as peaches the supermarket has purchased approach their dynamic expiration date regarding ripeness, the supermarket could reduce the price of the peaches such that they are depleted from inventory. The supermarket is not the only entity that has benefited from the dynamic nutritional information about the peaches, as data regarding the supermarket's preference for extended dynamic expiration dates is also available, and of particular interest, to the growers and packagers of the respective peaches. The grower and packager of the products with longer dynamic shelf life can additionally require a premium price for their products.

To illustrate still other benefits of the present invention the following example is provided of a consumer who purchases an information enabled ready-to-eat dinner and uses a microwave oven that is capable of processing information enabled nutritional substances to prepare the ready-to-eat meal. The consumer goes to the supermarket seeking a particular type of information enabled ready-to-eat meal. His selection process includes using a smartphone to read a QR code (providing dynamic information identifiers and URL to the nutritional substance information module) from the information enabled ready-to-eat dinner, using his smartphone to retrieve information from the nutritional substance information module, and verifying that the dinner meets his needs. The consumer later uses a microwave oven that is capable of processing information enabled nutritional substances to prepare the ready-to-eat dinner. In the process of conditioning the ready-to-eat dinner, the microwave reads the dynamic information identifier from a QR code on the ready-to-eat dinner. Using the dynamic information identifier the microwave retrieves information from the nutritional substance information module regarding the ready-to-eat dinner such as nutritional, organoleptic, or aesthetic values, ΔN information, and preparation information such as a conditioning protocol. The conditioning module, which could have multiple technologies, i.e. microwave, grill, oven, convection, steam etc., then provides the consumer options of preparation and ΔN information for nutritional values expected from exposure to different cooking methods and the time it is exposed. This will enable the consumer to choose his preferred option for preparing this ready-to-eat dinner according to the information retrieved (very much like the options in automobile GPS routing systems where the user can chose fastest route, shortest route and type of road, but here instead of the time and fuel consumed to get to a destination he would be able to have information on time, technology and nutritional values). When the consumer sets his preference and the Conditioning module finishes preparing the ready-to-eat dinner, the Conditioning module also provides the information regarding the ready-to-eat dinner it received from nutritional substance information module along with information it collected regarding the conditioning of the ready-to-eat dinner to the consumer module, which could be a smartphone or tablet computer. The consumer module, for example the consumer's smartphone, would obtain consumer information regarding the consumption of the ready-to-eat dinner. The smartphone can additionally obtain information relevant to the ready-to-eat dinner, which may include consumer feedback, observations, or measurements regarding the nutritional, organoleptic, aesthetic value of the ready-to-eat dinner before or after conditioning. The consumer module can share this information, through the information module, with those in the nutritional substance supply chain responsible for the ready-to-eat dinner.

As mentioned above, a consumer utilizing the consumer information system of the present invention can benefit from in-store routing technologies to assist his efforts to efficiently locate and purchase nutritional substances. An in-store routing technology placing little to no burden on the consumer, placing little to no burden on the retailer, facilitating improved shopping efficiency, and further allowing monetary benefit to both retailer and consumer based on transactions would favor adoption. Ideally, the consumer would be able to utilize his smart phone to navigate within any establishment that was appropriately navigation enabled. Ideally, the retail establishment would require no additional equipment or infrastructure to become navigation enabled.

A technology that can provide these advantages is ambient magnetic field anomaly-based positioning. The technology utilizes local variations in the Earth's magnetic field to map an indoor location. Variations to the Earth's magnetic field commonly exist inside of modern buildings and are a result of the overall structures of the building. The Earth's magnetic field and the magnetic anomalies created by a specific building create a unique three dimensional magnetic footprint of the interior of the building. Evolving software applications combined with smartphones capable of sensing and recording the resulting magnetic field anomalies can be used to map indoor locations. IndoorAtlas, Ltd. is a company that offers software tools enabling this technology, allowing retailers to magnetically map the interior of a building, such as a modern supermarket, using an Android smartphone and enabling consumers to navigate the interior of the building using their Android smartphone. Depending on the type of building, the accuracy of the technology in modern buildings ranges from 0.1 meter to 2 meters.

This enables the creation of indoor location-awareness applications to enhance the consumer's shopping experience, for example, at a supermarket. Such applications could provide the consumer not only with the availability and location of items on the consumer's shopping list, but with the most efficient route to follow within the supermarket when collecting the items, even leading them on the best route within the supermarket. Further, such applications could identify product alternatives, price, price per unit, promotions such as product rebates, transaction rebates specific to use of the application, and could further suggest complimentary items which are likely to accompany or enhance a target item.

Ideally, the nutritional substances identified would only include nutritional substances with dynamic information identifiers on the product itself, enabling the consumer to retrieve source and ΔN information from a nutritional substance information module also using their smartphone. If nutritional substances with and without dynamic information identifiers were identified, a transaction rebate related to the purchase of nutritional substances with dynamic information identifiers could be available.

Examples of how a consumer might benefit from utilizing such an indoor location-awareness application are now provided. The examples will focus on an application that works with the consumer's smartphone in an appropriately navigation enabled supermarket, such as a navigation-enabled supermarket enabled by IndoorAtlas' navigation software.

The consumer can use an indoor location-awareness application to create a shopping list for nutritional substances and identify the supermarket where he will shop. Alternatively, the consumer could create the shopping list and identify the supermarket where he will shop using other software and send it to the indoor location-awareness application. Using information regarding the contents of the chosen navigation-enabled supermarket the application creates a modified shopping list. The modified shopping list includes the primary items from the consumer's shopping list, and in some cases, variations or alternatives of those items. Further, the modified shopping list may include added items that are complimentary to the primary and alternative items. For example, shredded parmesan cheese could be suggested as a complementary item to pasta and pasta alternatives on the shopping list. Using the modified shopping list, the consumer can see and compare price or price per unit of items on list, including rebates associated with each item, which items can be purchased with an electronic coupon provided by the application, or which items are supplied with a dynamic information identifier. It is preferable that the modified shopping list is generated and presented to the consumer before the consumer begins shopping, in which case the consumer may select various primary, alternative, and complementary items. When the consumer has accepted items from the modified shopping list to create a final list, the application can generate the best in-store route to retrieve the items. The application can still retrieve and still show the items not accepted, in case the consumer wants to reconsider an item while shopping.

The consumer now has a highly evolved shopping plan, which takes into consideration various product criteria and provides a targeted in-store route by which to retrieve the items. As the consumer follows the in-store route and collects items from the final list, he can indicate through his smartphone that the items have been collected. He may also encounter an item on the final list that he decides not to purchase. For example, he might remember that he already has a particular item at home, in which case he can create a modified final list by deleting the item. The application could then generate a new in-store route based upon the modified final list, which includes the remaining items and the consumer's current location. Alternatively, he may utilize his smartphone to read a QR code with the item's dynamic information identifier and URL to the nutritional substance information module to retrieve source or ΔN information regarding an item from the nutritional substance information module and decide he is no longer interested and would rather consider a previously identified alternative item. In this case, he could create a modified final list by accepting the alternative item still shown on the final list and unselecting the item he has lost interest in. The application could then generate a new in-store route based upon the modified final list, which includes the newly accepted item, the remaining items, and the consumer's current location. In still another alternative, the consumer may remember an item that was not originally on his shopping list and add it to the final list, creating a modified final list. The application could then generate a new in-store route based upon the modified final list, which includes the newly added item, the remaining items, and the consumer's current location.

Rebates related to transactions resulting from or assisted by the use of the application could be structured in various ways. For example, rebates could be based simply on a rebate per purchase methodology. Rebates might be structured depending upon hierarchy of the item on the consumer's shopping list, for example depending upon if the purchased item was a primary shopping list item, an alternative item, or a complimentary item. Rebates could be related to the presence of a dynamic information identifier on the purchased item. Rebates could be related to specific supplier or in-store promotions presented to the consumer through the application.

After check out, the consumer can scan the receipt using his smartphone and transmit the information regarding purchases resulting from or assisted by the use of the application to a redemption resource, which could be the application provider. Alternatively, the supermarket could transmit this information along with a consumer identification code. This would ideally enable the application provider to redeem fees from the suppliers of the items purchased. The application provider would in turn provide the appropriate rebates to the consumer. The consumer rebates may take any number of forms, including direct deposit to a consumer account, periodic checks, or credit codes redeemable at suppliers or supermarkets participating in the application rebate program. Further, the application provider would provide monetary compensation to the retailer or supermarket for transactions resulting from or assisted by the use of the application. These transaction-based services are enhanced by the usage of ambient magnetic field anomaly-based positioning technology, since the routing to products is independent of in-store communication systems provided by a retailer and, also, independent of systems based upon GPS or other triangulation technologies. Thus, the transaction-based services using ΔN information can be readily associated with, or coupled to, the application using the ambient magnetic field anomaly-based positioning technology.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. Any claims intended to be treated under 35 U.S.C. §112, ¶ 6 will begin with the words “means for.” Accordingly, the applicant reserves the right to add additional claims after filing the application to pursue such additional claim forms for other aspects of the invention.

1. A communication system for nutritional substances comprising:
a nutritional substance database comprising ΔN information for at least one nutritional substance;
a consumer database comprising information relating the consumer and the at least one nutritional substance;
a consumer interface means for retrieval of information related to the consumer by said consumer, and information from said nutritional substance database, and
an ambient magnetic field anomaly-based positioning indoor navigation system available at the consumer interface for locating said at least one nutritional substance.

2. A communication system for nutritional substances according to claim 1 further comprising:
means for associating a rebate amount with purchasing said nutritional substance, said means comprising at least one of a human readable, computer readable, barcode, QR code, RF readable code, or electronically readable code.

3. A communication system for nutritional substances according to claim 2 wherein the ambient magnetic field anomaly-based positioning indoor navigation system operates with the consumer interface to associate the transaction-based services using ΔN information to an application using the ambient magnetic field anomaly-based positioning technology.

4. A communication system for nutritional substances according to claim 1 wherein: said nutritional substance database further comprises creation or origin information for said nutritional substance.

5. A communication system for nutritional substances according to claim 1 wherein: the means for retrieval of information from said nutritional substance database is accomplished using a dynamic information identifier provided or associated with said nutritional substance.

6. A communication system for nutritional substances according to claim 5 wherein: said dynamic information identifier is human readable, computer readable, barcode, QR code, RF readable code, or electronically readable code.

7. A method of obtaining and associating consumption and source information for nutritional substances comprising:
obtaining consumption information for a nutritional substance;
identifying source information for the nutritional substance based upon reference information provided on the nutritional substance;
associating the consumption information with the source information; and
conveying indoor navigation information for locating the nutritional substance using ambient magnetic field anomaly-based positioning.

8. A method of obtaining and associating consumption and source information for nutritional substances according to claim 7 further comprising:
identifying ΔN information for the nutritional substance.

9. A method of obtaining and associating consumption and source information for nutritional substances according to claim 7 further comprising:
defining a rebate for purchasing the nutritional substance.

10. A method of obtaining and associating consumption and source information for nutritional substances according to claim 7 further comprising:
defining a rebate for selling the nutritional substance.

11. A method of obtaining and associating consumption and source information for nutritional substances according to claim 7 wherein:
the source information for the nutritional substance is referenced by a dynamic information identifier.

12. A method of obtaining and associating consumption and source information for nutritional substances according to claim 7 wherein:
the source information for the nutritional substance comprises creation or origin information.

13. A method of obtaining and associating consumption and source information for nutritional substances according to claim 11 wherein:
said dynamic information identifier comprises at least a portion of the data stored by a QR code provided with the nutritional substance.

14. A method of obtaining and associating consumption and source information for nutritional substances according to claim 13 wherein:
said QR code further stores a URL for hotlinking a user to a nutritional substance information module.

15. A communication system for nutritional substances comprising:
an information storage system containing source information for a nutritional substance;
a locator for obtaining information for a specific consumer of the nutritional substance;
a nutritional substance information retriever for retrieving information regarding the nutritional substance;
means for retrieving information regarding an indoor location of the nutritional substance; and
an indoor-location retriever using ambient magnetic field anomaly-based positioning for indoor navigation for locating said at least one nutritional substance.

16. A communication system for nutritional substances according to claim 15 wherein:
said locator includes means for determining a recommended route for collecting the nutritional substance.

17. A communication system for nutritional substances according to claim 16 further comprising:
a dynamic information identifier referenced to said source information for the nutritional substance.

18. A communication system for nutritional substances according to claim 17 further including:
means for providing ΔN information for use by said storage system.

19. A communication system for nutritional substances according to claim 17 further including:
said dynamic information identifier comprises at least a portion of the data stored by a QR code provided with the nutritional substance.
